(19) United States
(12) Patent Application Publication
(10) Pub. No.: US 2007/0070179 A1
(43) Pub. Date: Mar. 29, 2007

(54) Method and system for a reconfigurable OFDM radio

(76) Inventor: Pieter van Rooyen, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/237,002

(22) Filed: Sep. 28, 2005

(51) Int. Cl. H04N 7/14

(52) U.S. Cl. 348/14.02; 348/14.01

(57) ABSTRACT

Aspects of a method and system for a reconfigurable OFDM radio are presented. Aspects of the method may include reconfiguring a single OFDM chip to process a received DVB-H video broadcast signal and at least one of the following: a received IEEE 802.11 WLAN signal, and a received IEEE 802.16 MAN signal. Aspects of the system may include a processor that reconfigures a single OFDM chip to process a received DVB-H video broadcast signal and at least one of the following: a received IEEE 802.11 WLAN signal, and a received IEEE 802.16 MAN signal. A machine readable storage may include a computer program, having at least one code section that may be executable by a machine, that causes the machine to perform steps for reconfiguring a single OFDM chip as described above.

### CROSS-REFERENCE TO RELATED APPLICATIONS/INCORPORATION BY REFERENCE

This application makes reference to:
U.S. patent application Ser. No. ______ (Attorney Docket No. 16848US01), filed Sep. 28, 2005; and
U.S. patent application Ser. No. ______ (Attorney Docket No. 16849US01), filed Sep. 28, 2005.

All of the above stated applications are hereby incorporated herein by reference in their entirety.

### FIELD OF THE INVENTION

Certain embodiments of the invention relate to communication of information via a plurality of different networks. More specifically, certain embodiments of the invention relate to a method and system for a reconfigurable orthogonal frequency division multiplexing (OFDM) radio.

### BACKGROUND OF THE INVENTION

Broadcasting and telecommunications have historically occupied separate fields. In the past, broadcasting was largely an “over-the-air” medium while wired media carried telecommunications. That distinction may no longer apply as both broadcasting and telecommunications may be delivered over either wired or wireless media. Present development may adapt broadcasting to mobility services. One limitation has been that broadcasting may often require high bit rate data transmission at rates higher than could be supported by existing mobile communications networks. However, with emerging developments in wireless communications technology, even this obstacle may be overcome.

Terrestrial television and radio broadcast networks have made use of high power transmitters covering broad service areas, which enable one-way distribution of content to user equipment such as televisions and radios. By contrast, wireless telecommunications networks have made use of low power transmitters, which have covered relatively small areas known as “cells”. Unlike broadcast networks, wireless networks may be adapted to provide two-way interactive services between users of user equipment such as telephones and computer equipment.

The introduction of cellular communications systems in the late 1970's and early 1980's represented a significant advance in mobile communications. The networks of this period may be commonly known as first generation, or “1G” systems. These systems were based on analog, circuit-switching technology, the most prominent of these systems may have been the advanced mobile phone system (AMPS). Second generation, or “2G” systems ushered improvements in performance over 1G systems and introduced digital technology to mobile communications. Exemplary 2G systems include the global system for mobile communications (GSM), digital AMPS (D-AMPS), and code division multiple access (CDMA). Many of these systems have been designed according to the paradigm of the traditional telephony architecture, often focused on circuit-switched services, voice traffic, and supported data transfer rates up to 14.4 kbits/s. Higher data rates were achieved through the deployment of “2.5G” networks, many of which were adapted to existing 2G network infrastructures. The 2.5G networks began the introduction of packet-switching technology in wireless networks. However, it is the evolution of third generation, or “3G” technology which may introduce fully packet-switched networks, which support high-speed data communications.

The general packet radio service (GPRS), which is an example of a 2.5G network service oriented for data communications, comprises enhancements to GSM which required additional hardware and software elements in existing GSM network infrastructures. Where GSM may allot a single time slot in a time division multiple access (TDMA) frame, GPRS may allot up to 8 such time slots providing a data transfer rate of up to 115.2 kbits/s. Another 2.5G network, enhanced data rates for GSM evolution (EDGE), also comprises enhancements to GSM, and like GPRS, EDGE may allocate up to 8 time slots in a TDMA frame for packet-switched, or packet mode, transfers. However, unlike GPRS, EDGE adapts 8 phase shift keying (8-PSK) modulation to achieve data transfer rates which may be as high as 384 kbits/s.

The universal mobile telecommunications system (UMTS) is an adaptation of a 3G system, which is designed to offer integrated voice, multimedia, and Internet access services to portable user equipment. The UMTS adapts wideband CDMA (W-CDMA) to support data transfer rates, which may be as high as 2 Mbits/s. One reason why W-CDMA may support higher data rates is that W-CDMA channels may have a bandwidth of 5 MHz versus the 200 kHz channel bandwidth in GSM. A related 3G technology, high speed downlink packet access (HSDPA), is an Internet protocol (IP) based service oriented for data communications, which adapts W-CDMA to support data transfer rates of the order of 10 Mbits/s. HSDPA achieves higher data rates through a plurality of methods. For example, many transmission decisions may be made at the base station level, which is much closer to the user equipment as opposed to being made at a mobile switching center or office. These may include decisions about the scheduling of data to be transmitted, when data are to be retransmitted, and assessments about the quality of the transmission channel. HSDPA may also utilize variable coding rates in transmitted data. HSDPA also supports 16-level quadrature amplitude modulation (16-QAM) over a high-speed downlink shared channel (HS-DSCH), which permits a plurality of users to share an air interface channel.

The multiple broadcast/multicast service (MBMS) is an IP datacast service, which may be deployed in EDGE and UMTS networks. The impact of MBMS is largely within the network in which a network element adapted to MBMS, the broadcast multicast service center (BM-SC), interacts with other network elements within a GSM or UMTS system to manage the distribution of content among cells within a network. User equipment may be required to support functions for the activation and deactivation of MBMS bearer service. MBMS may be adapted for delivery of video and audio information over wireless networks to user equipment. MBMS may be integrated with other services offered over the wireless network to realize multimedia services, such as multicasting, which may require two-way interaction with user equipment.

Standards for digital television terrestrial broadcasting (DTTB) have evolved around the world with different systems being adopted in different regions. The three leading DTTB systems are, the advanced standards technical committee (ATSC) system, the digital video broadcast terrestrial (DVB-T) system, and the integrated service digital broadcasting terrestrial (ISDB-T) system. The ATSC system has largely been adopted in North America, South America, Taiwan, and South Korea. This system adapts trellis coding and 8-level vestigial sideband (8-VSB) modulation. The DVB-T system has largely been adopted in Europe, the Middle East, Australia, as well as parts of Africa and parts of Asia. The DVB-T system adapts coded orthogonal frequency division multiplexing (COFDM). The ISDB-T system has been adopted in Japan and adapts bandwidth segmented transmission orthogonal frequency division multiplexing (BST-OFDM). The various DTTB systems may differ in important aspects, some systems employ a 6 MHz channel separation, while others may employ 7 MHz or 8 MHz channel separations. Planning for the allocation of frequency spectrum may also vary among countries with some countries integrating frequency allocation for DTTB services into the existing allocation plan for legacy analog broadcasting systems. In such instances, broadcast towers for DTTB may be co-located with broadcast towers for analog broadcasting services with both services being allocated similar geographic broadcast coverage areas. In other countries, frequency allocation planning may involve the deployment of single frequency networks (SFNs), in which a plurality of towers, possibly with overlapping geographic broadcast coverage areas (also known as “gap fillers”), may simultaneously broadcast identical digital signals. SFNs may provide very efficient use of broadcast spectrum as a single frequency may be used to broadcast over a large coverage area in contrast to some of the conventional systems, which may be used for analog broadcasting, in which gap fillers transmit at different frequencies to avoid interference.

Even among countries adopting a common DTTB system, variations may exist in parameters adapted in a specific national implementation. For example, DVB-T not only supports a plurality of modulation schemes, comprising quadrature phase shift keying (QPSK), 16-QAM, and 64 level QAM (64-QAM), but DVB-T offers a plurality of choices for the number of modulation carriers to be used in the COFDM scheme. The “2K” mode permits 1,705 carrier frequencies which may carry symbols, each with a useful duration of 224 μs for an 8 MHz channel. In the “8K” mode there are 6,817 carrier frequencies, each with a useful symbol duration of 896 μs for an 8 MHz channel. In SFN implementations, the 2K mode may provide comparatively higher data rates but smaller geographical coverage areas than may be the case with the 8K mode. Different countries adopting the same system may also employ different channel separation schemes.

While 3G systems are evolving to provide integrated voice, multimedia, and data services to mobile user equipment, there may be compelling reasons for adapting DTTB systems for this purpose. One of the more notable reasons may be the high data rates which may be supported in DTTB systems. For example, DVB-T may support data rates of 15 Mbits/s in an 8 MHz channel in a wide area SFN. There are also significant challenges in deploying broadcast services to mobile user equipment. Many handheld portable devices, for example, may require that services consume minimum power to extend battery life to a level, which may be acceptable to users. Another consideration is Doppler effect in moving user equipment, which may cause inter-symbol interference in received signals. Among the three major DTTB systems, ISDB-T was originally designed to support broadcast services to mobile user equipment. While DVB-T may not have been originally designed to support mobility broadcast services, a number of adaptations have been made to provide support for mobile broadcast capability. The adaptation of DVB-T to mobile broadcasting is commonly known as DVB handheld (DVB-H).

To meet requirements for mobile broadcasting the DVB-H specification may support time slicing to reduce power consumption at the user equipment, addition of a 4K mode to enable network operators to make tradeoffs between the advantages of the 2K mode and those of the 8K mode, and an additional level of forward error correction on multiprotocol encapsulated data - forward error correction (MPE-FEC) to make DVB-H transmissions more robust to the challenges presented by mobile reception of signals and to potential limitations in antenna designs for handheld user equipment. DVB-H may also use the DVB-T modulation schemes, like QPSK and 16-quadrature amplitude modulation (16-QAM), which may be most resilient to transmission errors. MPEG audio and video services may be more resilient to error than data, thus additional forward error correction may not be required to meet DTTB service objectives.

Time slicing may reduce power consumption in user equipment by increasing the burstiness of data transmission. Instead of transmitting data at the received rate, under time slicing techniques, the transmitter may delay the sending of data to user equipment and send data later but at a higher bit rate. This may reduce total data transmission time over the air, time, which may be used to temporarily power down the receiver at the user equipment. Time slicing may also facilitate service handovers as user equipment moves from one cell to another because the delay time imposed by time slicing may be used to monitor transmitters in neighboring cells. The MPE-FEC may comprise Reed-Solomon coding of IP data packets, or packets using other data protocols. The 4K mode in DVB-H may utilize 3,409 carriers, each with a useful duration of 448 μs for an 8 MHz channel. The 4K mode may enable network operators to realize greater flexibility in network design at minimum additional cost. Importantly, DVB-T and DVB-H may coexist in the same geographical area. Transmission parameter signaling (TPS) bits which are carried in the header of transmitted messages may indicate whether a given DVB transmission is DVB-T or DVB-H, in addition to indicating whether DVB-H specific features, such as time slicing, or MPE-FEC are to be performed at the receiver. As time slicing may be a mandatory feature of DVB-H, an indication of time slicing in the TPS may indicate that the received information is from a DVB-H service.

With the convergence of next generation networks which offer a plurality integrated services which may be offered in disparate conventional networks come requirements for new capabilities in mobile terminals. Some conventional mobile terminals may be adapted to communicating with cellular networks only, while some receiver devices may be adapted to the reception of television and radio services only. Thus, users who wish to receive both broadcast and telecommunications services while mobile may be required to carry at least two devices, a mobile telephone, and one or more devices for the reception of television and radio broadcast services.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and a system for a reconfigurable orthogonal frequency division multiplexing (OFDM) radio, substantially as shown in and/or described in connections with at least one of the figures, and set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system for providing integrated services between a cellular network, WLAN and a digital video broadcast network, in accordance with an embodiment of the invention.

FIG. 2 is a block diagram of a mobile terminal that is adapted to receive VHF/UHF broadcasts, IEEE 802.11 communications, IEEE 802.16 communications and/or cellular communications, in accordance with an embodiment of the invention.

FIG. 3 is a block diagram of an exemplary RF integrated circuit (RFIC), in accordance with an embodiment of the invention.

FIG. 4 is a high-level block diagram of an exemplary system for a reconfigurable OFDM radio, in accordance with an embodiment of the invention.

FIG. 5 illustrates an exemplary IEEE 802.11 frame, which may be utilized in connection with an embodiment of the invention.

FIG. 6 is a block diagram illustrating an exemplary reconfigurable OFDM chip, in accordance with an embodiment of the invention.

FIG. 7 is a flow chart illustrating exemplary steps for reconfiguring a reconfigurable OFDM radio, in accordance with an embodiment of the invention.

### DETAILED DESCRIPTION OF THE INVENTION

Certain embodiments of the invention may be found in a method and system for a reconfigurable OFDM radio. Aspects of the method may include reconfiguring a single OFDM chip to process a received DVB-H video broadcast signal and at least one of the following: a received IEEE 802.11 WLAN signal, and a received IEEE 802.16 MAN signal. Aspects of the system may include a processor that reconfigures a single OFDM chip to process a received DVB-H video broadcast signal and at least one of the following: a received IEEE 802.11 WLAN signal, and a received IEEE 802.16 MAN signal. A machine readable storage may include a computer program, having at least one code section that may be executable by a machine, that causes the machine to perform steps for reconfiguring a single OFDM chip as described above.

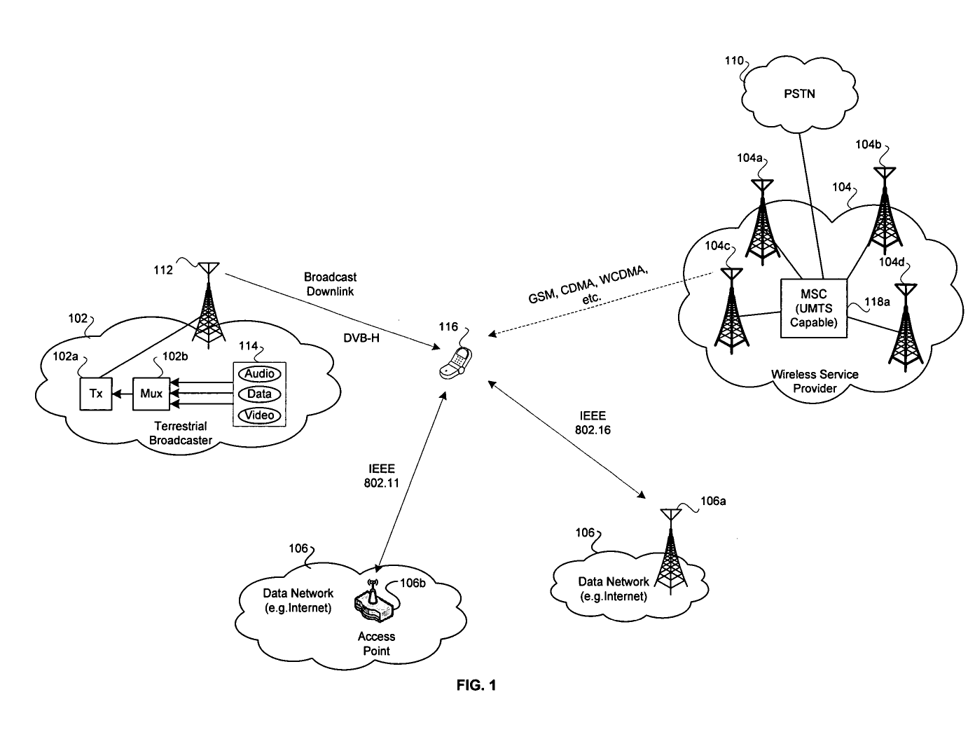

FIG. 1 is a block diagram of an exemplary system for providing integrated services between a cellular network, WLAN and a digital video broadcast network, in accordance with an embodiment of the invention. Referring to FIG. 1, there is shown a terrestrial broadcaster network 102, a wireless service provider network 104, a data network 106, a public switched telephone network 110, and a mobile terminal (MT) 116. The terrestrial broadcaster network 102 may comprise a transmitter (Tx) 102a, a multiplexer (Mux) 102b, and information content source 114. The content source 114 may also be referred to as a data carousel, which may comprise audio, data and video content. The terrestrial broadcaster network 102 may also comprise one or more VHF/UHF broadcast antennas 112. The wireless service provider network 104 may comprise a mobile switching center (MSC) 118a, and a plurality of cellular base stations 104a, 104b, 104c, and 104d. The data network 106 may comprise one or more broadcast antennas 106a and/or one or more access points 106b.

The terrestrial broadcaster network 102 may comprise suitable equipment that may be adapted to encode and/or encrypt data for transmission via the transmitter 102a. The transmitter 102a in the terrestrial broadcaster network 102 may be adapted to utilize VHF/UHF broadcast channels to communicate information to the mobile terminal 116. The multiplexer 102b associated with the terrestrial broadcaster network 102 may be utilized to multiplex data from a plurality of sources. For example, the multiplexer 102b may be adapted to multiplex various types of information such as audio, video and/or data into a single pipe for transmission by the transmitter 102a.

The access point (AP) 106b may comprise suitable circuitry, logic and/or code to communicate with the MT 116 in accordance with Institute of Electrical and Electronics Engineers (IEEE) standard 802.11, for example. The AP 106b may be adapted to enable the MT 116 to communicate information via the data network 106 such as the Internet, for example. The AP 106b and the MT 116 may communicate when they are collocated in a proximal area, for example, within a building. The broadcast antenna 106a may be adapted to enable the MT 116 to communicate information to the data network 106 in accordance with the IEEE 802.16 standard, for example. The broadcast antenna 106a and the MT 116 may communicate when they are collocated within a metropolitan area, for example.

The wireless service provider network 104 may be a cellular or personal communication service (PCS) provider. The term cellular as utilized herein refers to both cellular and PCS frequencies bands. Hence, usage of the term cellular may comprise any band of frequencies that may be utilized for cellular communication and/or any band of frequencies that may be utilized for PCS communication. The wireless service provider network 104 may utilize cellular or PCS access technologies such as GSM, CDMA, CDMA2000, WCDMA, AMPS, N-AMPS, and/or TDMA. The cellular network may be utilized to offer bi-directional services via uplink and downlink communication channels. In this regard, other bi-directional communication methodologies comprising uplink and downlink capabilities, whether symmetric or asymmetric, may be utilized.

Although the wireless service provider network 104 is illustrated as a GSM, CDMA, WCDMA based network and/or variants thereof, the invention is not limited in this regard. Accordingly, the wireless service provider network 104 may be an 802.11 based wireless network and/or wireless local area network (WLAN). The wireless service provider network 104 may also be adapted to provide 802.11 based wireless communication in addition to GSM, CDMA, WCDMA, CDMA2000 based network and/or variants thereof. In this case, the mobile terminal 116 may also be compliant with the 802.11 based wireless network.

The public switched telephone network (PSTN) 110 may be coupled to the MSC 118a. Accordingly, the MSC 118a may be adapted to switch calls originating from within the PSTN 110 to one or more mobile terminals serviced by the wireless service provider 104. Similarly, the MSC 118a may be adapted to switch calls originating from mobile terminals serviced by the wireless service provider 104 to one or more telephones serviced by the PSTN 110.

The data network 106 may be, for example, the Internet. The data network 106 may utilize a plurality of technologies related to the communication of information via a data network, such as the Internet protocol (IP), the transmission control protocol (TCP), or the user data protocol (UDP), for example. The data network 106 may not be limited to embodiments in the Internet, and may not be limited to the communication of data. The data network 106 may also be utilized for telephone and/or wireless communications. In this instantiation, the data network 106 may utilize a plurality of technologies related to telephone and/or wireless communications, such as H.323, and/or the session initiation protocol (SIP), for example. The data network may also be utilized to communicate audiovisual and/or multimedia information. The data network may utilize a plurality of technologies related to the communication of audiovisual and/or multimedia communications, such as the real time protocol (RTP), and/or the real time streaming protocol (RTSP), for example.

The information content source 114 may comprise a data carousel. In this regard, the information content source 114 may be adapted to provide various information services, which may comprise online data including audio, video and data content. The information content source 114 may also comprise file download, and software download capabilities.

The mobile terminal (MT) 116 may comprise suitable logic, circuitry and/or code that may be adapted to handle the processing of uplink and downlink cellular channels, WLAN channels and/or DVB-H channels for various access technologies and broadcast UHF/VHF technologies. In an exemplary embodiment of the invention, the mobile terminal 116 may be adapted to utilize one or more cellular access technologies such as GSM, GPRS, EDGE, CDMA, WCDMA, and CDMA2000. The MT 116 may be adapted to utilize one or more wireless data communications access technologies such as, but not limited to, IEEE 802.11, and IEEE 802.16. The MT 116 may also be adapted to receive and process VHF/UHF broadcast signals in the VHF/UHF bands. For example, a mobile terminal 116 may be adapted to receive and process DVB-H signals.

In an embodiment of the invention, a mobile terminal 116 may be adapted to utilize a single orthogonal frequency division multiplexing (OFDM) integrated circuit that receives and processes VHF/UHF channels, IEEE 802.11 WLAN channels and/or IEEE 802.16 metropolitan area network (MAN) channels. The mobile terminal 116 may also be adapted to utilize a plurality of cellular integrated circuits for receiving and processing a corresponding plurality of cellular and/or PCS channels. In this regard, the plurality of cellular integrated circuits may be adapted to handle different cellular access technologies. For example, at least one of the cellular integrated circuits may be adapted to handle GSM, and at least one of the cellular integrated circuits may be adapted to handle WCDMA. For broadcast channels, each of the plurality of OFDM integrated circuits may be adapted to handle at least one VHF/UHF channel, WLAN channel and/or MAN channel.

The MT 116 may communicate with the data network 106, the terrestrial broadcaster network 102 and/or wireless service provider network 104 individually, or simultaneously in any combination. For example, the MT 116 may receive a DVB-H signal from terrestrial broadcaster network 102 while communicating information to the data network 106 via an access point 106b and/or a broadcast antenna 106a. The MT 116 may utilize IEEE 802.11 and/or IEEE 802.16 to communicate with the data network 106. The MT 116 may also utilize DVB-H to communicate with the terrestrial broadcaster network 102. The MT 116 may utilize any of a plurality of PCS access technologies to communicate with the wireless service provider network 104.

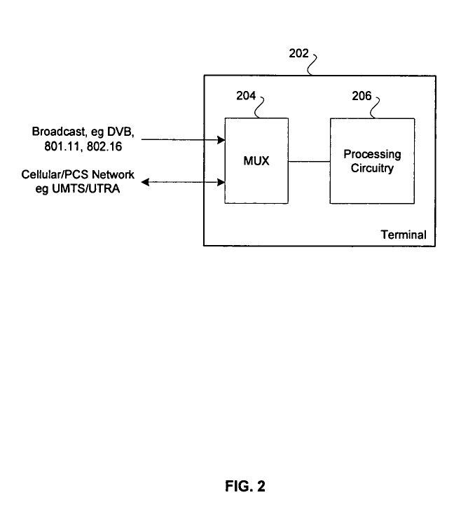

FIG. 2 is a block diagram of a mobile terminal that is adapted to receive VHF/UHF broadcasts, IEEE 802.11 communications, IEEE 802.16 communications and/or cellular communications, in accordance with an embodiment of the invention. Referring to FIG. 2, there is shown a mobile terminal (MT) 202. The mobile terminal 202 may comprise multiplexer (MUX) 204 and processing circuitry 206.

The multiplexer 204 may comprise suitable logic circuitry and/or code that may be adapted to multiplex incoming signals, which may comprise at least one VHF/UHF broadcast channel, IEEE 802.11 channel, IEEE 802.16 channel and/or cellular channel. The cellular channel may be within the range of both cellular and PCS frequency bands.

The processing circuitry 206 may comprise, for example, an RF integrated circuit (RFIC) or RF front end (RFFE). In this regard, the processing circuitry 206 may comprise at least one receiver front end (RFE) circuit. A first RFE circuit may be adapted to handle processing of the VHF/UHF broadcast channel, the IEEE 802.11 channel and/or the IEEE 802.16 channel. A second RFE circuit may be adapted to handle a cellular channel.

The basic function of an RFIC may comprise processing RF and baseband signals at the mobile terminal 202. The tasks performed by an RFIC may comprise, but are not limited to, modulation or demodulation, low pass filtering, and digital to analog (D/A) or analog to digital (A/D) conversion. When receiving an RF signal, the RFIC may demodulate the RF signal to the baseband frequency. Subsequently, the baseband frequency signal may undergo low pass filtering to eliminate sideband artifacts from the demodulation process. Later, the RFIC may perform an A/D conversion before transmitting a digital baseband signal. When receiving a baseband signal, the RFIC may perform a D/A conversion, subsequently modulating the signal to an RF frequency.

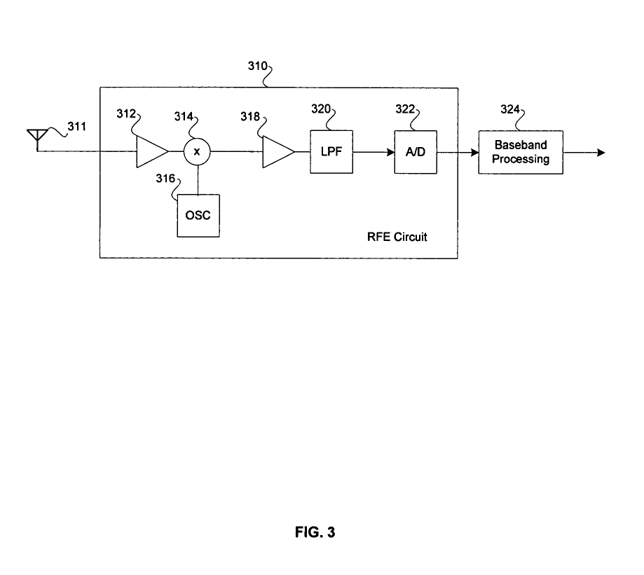

FIG. 3 is a block diagram of an exemplary RF integrated circuit (RFIC), in accordance with an embodiment of the invention. Referring to FIG. 3, there is shown antenna 311, receiver front end (RFE) circuit 310, and baseband processing block 324. The receiver front end (RFE) circuit 310 may comprise a low noise amplifier (LNA) 312, a mixer 314, an oscillator 316, a low noise amplifier or amplifier 318, a low pass filter 320 and an analog-to-digital converter (A/D) 322.

The antenna 311 may be adapted to receive at least one of a plurality of signals. For example, the antenna 311 may be adapted to receive a plurality of signals in the GSM band, a plurality of signals in the WCDMA and and/or a plurality of signals in the VHF/UHF frequency band, for example.

The receiver front end (RFE) circuit 310 may comprise suitable circuitry, logic and/or code that may be adapted to convert a received RF signal to a baseband signal. An input of the low noise amplifier 312 may be coupled to the antenna 311 so that it may receive RF signals from the antenna 311. The low noise amplifier 312 may comprise suitable logic, circuitry, and/or code that may be adapted to receive an input RF signal, from the antenna 311, and to amplify the input RF signal while limiting the level of additional noise added to the amplified signal as a result of the amplification.

The mixer 314 in the RFE circuit 310 may comprise suitable circuitry and/or logic that may be adapted to mix an output signal, from the low noise amplifier 312, with an oscillator signal, generated by the oscillator 316. The oscillator 316 may comprise suitable circuitry and/or logic that may be adapted to provide a oscillating signal that may be utilized by the mixer 314 to downconvert the output signal, generated from the output of the low noise amplifier 212, from RF down to a baseband frequency. Given a signal from the LNA 212 characterized by a frequency f_{RF}, and a signal from the oscillator 316 characterized by a frequency f_{osc}, the signal generated by the mixer 314 may comprise a plurality of frequency components. Each of the frequency components may be characterized by a frequency. For example, one frequency component may be characterized by a frequency f_{RF}−f_{osc}. This frequency component may represent a baseband frequency. Another frequency component in the signal generated by the mixer 314 may be characterized by a frequency f_{RF}+f_{osc}. This frequency component may represent an upper band frequency.

The low noise amplifier (LNA) or amplifier 318 may comprise suitable circuitry and/or logic that may be adapted to provide low noise amplification of an input signal received from the mixer 314. An output of the low noise amplifier or amplifier 318 may be communicated to the low pass filter 320. The low pass filter block 320 may comprise suitable logic, circuitry and/or code that may be adapted to low pass filter the output signal generated by the LNA or amplifier 318. The low pass filter block 320 may retain a desired signal, for example a baseband signal, and filter out unwanted signal components, such as higher frequency signal components. The unwanted signal components may comprise the upper band frequency component in the signal generated by the mixer 314. The higher frequency signal components may also comprise noise, for example. An output of the low pass filter 320 may be communicated to the analog-digital converter 322 for processing.

The analog-to-digital converter (A/D) 322 may comprise suitable logic circuitry and/or code that may be adapted to convert an analog input signal, for example one received from of the low pass filter 320, to a digital output signal. The analog-to-digital converter 322 may generate a sampled digital representation of the analog input signal that may be communicated to the baseband processing block 324 for subsequent processing. The baseband processing block 324 may comprise suitable logic, circuitry and/or code that may be adapted to process digital baseband signals received from the A/D 322, for example. The subsequent processing performed by the baseband processing block 324 may comprise the inspection of binary bits contained in the digital baseband signals, and extraction of information based on the inspected binary bits. The information may be utilized to adapt parameters utilized by the baseband processing block 324 and/or RFE circuit 310. For example, the extracted information may comprise a modulation type. The modulation type may subsequently be utilized by the A/D 322 and/or baseband processing block 324 when processing subsequent received signals.

Although the A/D 322 is illustrated as being a component in the RFE circuit 310, the invention may not be so limited. Accordingly, the A/D 322 may be a component in the baseband processing block 324. In operation, the RFE circuit 310 may be adapted to receive RF signals via antenna 311 and to convert the received RF signals to a sampled digital representation, which may be communicated to the baseband processing block 324 for subsequent processing.

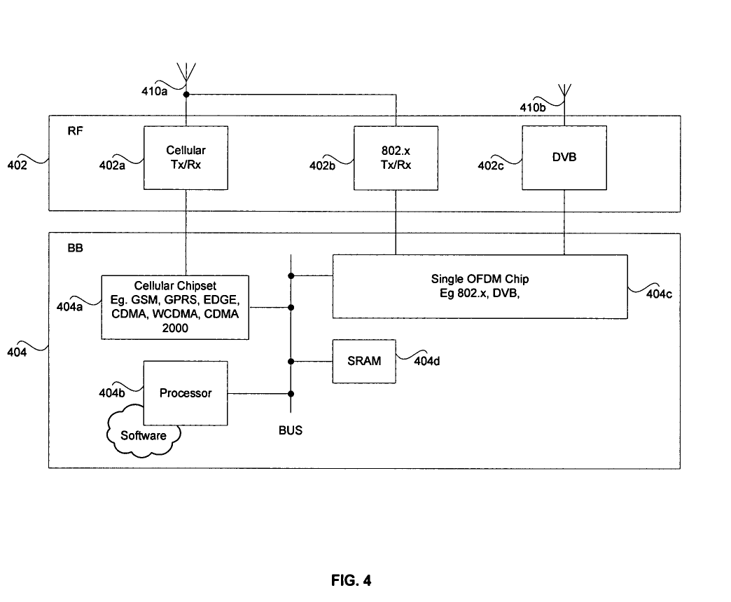

FIG. 4 is a high-level block diagram of an exemplary system for a reconfigurable OFDM radio, in accordance with an embodiment of the invention. Referring to FIG. 4, there is shown an RFIC 402, baseband processing circuitry 404, and antennas 410a and 410b. The RFIC 402 may comprise a plurality of RF processing circuits 402a, 402b and 402c, for example. The RF processing circuits 402a, 402b and 402c may be integrated into a single integrated circuit (IC) chip. The baseband processing circuitry 404 may comprise a plurality of baseband processing circuits 404a and 404c, a processor 404b, and memory 404d.

The antenna 410a may be adapted to receiving RF channels comprising a range of frequencies associated with cellular channels and/or IEEE 802.11 channels and/or IEEE 802.16 channels. The antenna 410b may be adapted to receiving RF channels comprising a range of frequencies associated with DVB-H channels.

The RF processing circuit 402a may comprise suitable circuitry, logic and/or code that may be adapted to converting an RF signal, received via a cellular channel, to a baseband signal. The RF processing circuit 402a may also comprise suitable circuitry, logic and/or code that may be adapted to converting a baseband signal to an RF signal that may be subsequently transmitted via a cellular channel. The RF processing circuit 402a may be referred to as a cellular transmitter and receiver 402a. The RF processing circuit 402b may comprise suitable circuitry, logic and/or code that may be adapted to converting an RF signal, received via an IEEE 802.11 channel and/or IEEE 802.16 channel, to a baseband signal. The RF processing circuit 402b may also comprise suitable circuitry, logic and/or code that may be adapted to converting a baseband signal to an RF signal that may be subsequently transmitted via an IEEE 802.11 channel and/or IEEE 802.16 channel. The RF processing circuit 402b may be referred to as an IEEE 802 transmitter and receiver 402b. The RF processing circuit 402c may comprise suitable circuitry, logic and/or code that may be adapted to converting an RF signal, received via a DVB-H channel, to a baseband signal. The RF processing circuit 402c may be referred to as a DVB receiver 402c.

The baseband processing circuit 404a may comprise a plurality of IC chips referred to as a chipset. The baseband processing circuit 404a may be referred to as a cellular chipset 404a. The cellular chipset 404a may comprise suitable circuitry, logic and/or code that may be adapted to processing baseband information that was extracted from a signal that may have been received via a wireless service provider network 104. The signal may have been associated with a cellular channel.

The baseband processing circuit 404c may comprise a single IC chip. The baseband processing circuit 404c may be referred to as an orthogonal frequency division multiplexing (OFDM) chip 404c. The OFDM chip 404c may comprise suitable circuitry, logic and/or code that may be adapted to processing baseband information that was extracted from a signal that may have been received via an IEEE 802.11 channel, an IEEE 802.16 channel and/or DVB-H channel, for example.

The processor 404b may comprise suitable logic, circuitry, and/or code that may be adapted to perform control and/or management operations for the baseband processing circuitry 404. In this regard, the processor 404b may be adapted to generate at least one signal for configuring the OFDM chip 404c. Moreover, the processor 404b may be adapted to arbitrate and/or schedule communications between the cellular chipset 404a and the OFDM chip 404c when collaborative communication is to be utilized. Collaborative communication may be utilized at an MT 116 when information received via a cellular channel corresponds to information received via a DVB-H channel, IEEE 802.11 WLAN channel, and/or an IEEE 802.16 MAN channel, for example. In some instances, the arbitration and/or scheduling operations may be performed by logic, circuitry, and/or code implemented separately from the processor 404b. The memory 404d may comprise suitable circuitry, logic and/or code that may be utilized by the processor 404b to store information related to the communication of information via a cellular channel, a DVB-H channel, an IEEE 802.11 WLAN channel and/or a IEEE 802.11 MAN channel, for example.

In operation, the antenna 410a may receive an RF signal via a cellular channel. The cellular transmitter and receiver 402a may convert the received RF signal to a baseband signal. The cellular chipset 404a may process the baseband signal. Subsequently, the cellular chipset 404a may cause information that is associated with the received RF signal to be stored in the memory 404d. The processor 404b may cause the stored information to be retrieved from the memory 404d. The retrieved information may be utilized to control the processing of subsequent information received, via the cellular channel, by the cellular transmitter and receiver 402a and/or the cellular chipset 404a.

The antenna 410a may also receive an RF signal via an IEEE 802.11 channel or an IEEE 802.16 channel. The IEEE 802 transmitter and receiver 402b may convert the received RF signal to a baseband signal. The OFDM chip 404c may process the baseband signal. The baseband signal may comprise a frame of binary bits. The frame may comprise a plurality of bits. A first portion of the frame may comprise preamble and header information. The subsequent portion of the frame may comprise payload information. The OFDM chip 404c may inspect the header and/or preamble information. Based on information contained in the header and/or preamble, the OFDM chip 404c may cause information that is associated with the received RF signal to be stored in the memory 404d. The processor 404b may cause the stored information to be retrieved from the memory 404d. The retrieved information may be utilized by the processor 404b to configure the OFDM chip 404c. The OFDM chip 404c may subsequently process the payload based on the configuration. The payload may comprise an IEEE 802 frame as specified by an applicable IEEE 802 standard. The retrieved information may also be utilized by the processor 404b to control the processing of subsequent information received, via the IEEE 802.11 channel and/or IEEE 802.16 channel, by the IEEE 802 transmitter and receiver 402b.

The antenna 410b may also receive an RF signal via a DVB-H channel. The DVB-H receiver 402c may convert the received RF signal to a baseband signal. The OFDM chip 404c may process the baseband signal. The baseband signal may comprise a frame of binary bits. The frame may comprise a plurality of bits. A first portion of the frame may comprise preamble and header information. The subsequent portion of the frame may comprise payload information. The OFDM chip 404c may inspect the header and/or preamble information. Based on information contained in the header and/or preamble, the OFDM chip 404c may cause information that is associated with the received RF signal to be stored in the memory 404d. The processor 404b may cause the stored information to be retrieved from the memory 404d. The retrieved information may be utilized by the processor 404b to configure the OFDM chip 404c. The OFDM chip 404c may subsequently process the payload based on the configuration. The payload may comprise a DVB-H frame as specified by an applicable DVB standard and/or European Telecommunications Standards Institute (ETSI) standard. The retrieved information may also be utilized by the processor 404b to control the processing of subsequent information received, via the DVB-H channel, by the DVB receiver 402c.

Based on information stored in the memory 404d, for example, the processor may determine that there is a collaborative communication comprising a signal received via any combination of a cellular channel, IEEE 802.11 channel, IEEE 802.16 channel and/or DVB-H channel. Information from collaborating communication channels may be processed by the processor 404b and/or subsequent processor in accordance with the collaborative nature of the communication. For example, a MT 116 may receive a video broadcast via a terrestrial broadcaster network 102 while the MT 116 is simultaneously communicating via a wireless service provider network 104. Information from the collaborative communication may be presented simultaneously at the MT 116 to a user. For example, the user may be able to utilize the MT 116 to engage in a telephone conversation while also watching an audiovisual broadcast displayed at the MT 116.

In another aspect, collaborative communications may comprise receiving information via one of a cellular channel, IEEE 802.11 channel, IEEE 802.16 channel and/or DVB-H channel, and subsequently transmitting the received information via another of the cellular channel, IEEE 802.11 channel, IEEE 802.16 channel and/or DVB-H channel. This is a form of collaborative communication that may be referred to as transcoding. For example, if the MT 116 receives a signal via a cellular channel, corresponding information stored in the memory 404d may enable the processor 404b to determine that the received information may be subsequently transmitted by the MT 116 via an IEEE 802.11 channel. The processor 404b may direct processing circuitry 206 to transcode the information received via the cellular channel. The transcoded information may be converted into a form that is suitable for transmission via an IEEE 802.11 channel. The transcoded information may be stored in memory 404d. The OFDM chip 404c may subsequently cause the transcoded information to be retrieved from the memory 404d, communicated to the IEEE 802 transmitter and receiver 402b, and transmitted via the IEEE 802.11 channel.

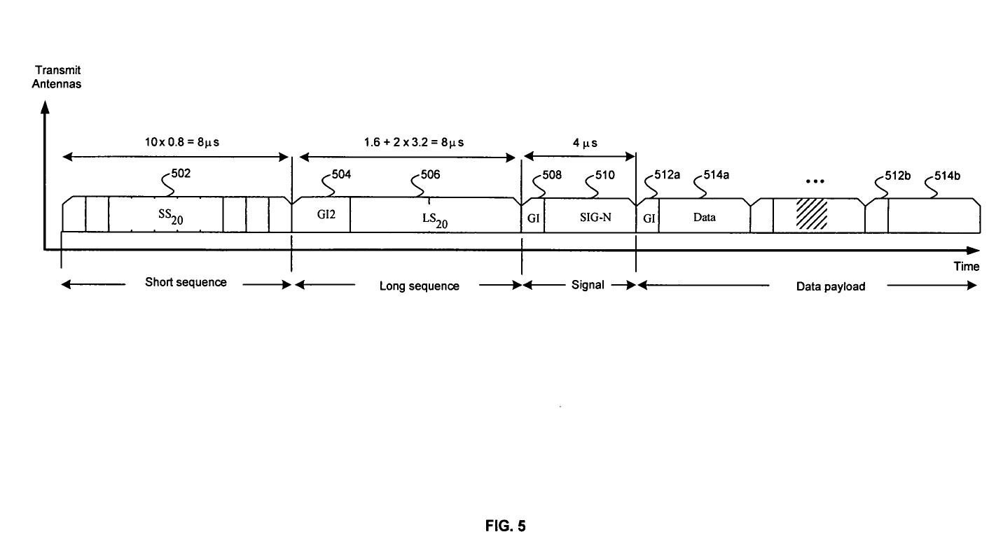

FIG. 5 illustrates an exemplary IEEE 802.11 frame, which may be utilized in connection with an embodiment of the invention. With reference to FIG. 5, there is shown a frame, or physical layer protocol data unit (PPDU), that may comprise a short sequence field 502, a training symbol guard interval (GI2) field 504, a long sequence field 506, a guard interval (GI) field 508, a signal (SIG-N) field 510, a plurality of guard interval fields 512a . . . 512b, and a plurality of data fields 514a . . . 514b. A physical layer service data unit (PSDU) may comprise a header and a data payload. The preamble of the PSDU may comprise a short sequence field 502, and a long sequence field 506. The header portion of the PSDU may comprise the SIG-N field 510. The data payload of the PSDU may comprise the plurality of data fields 514a, . . . , 514b. A plurality of bits, associated with each of the fields, may be transmitted via an RF channel encoded as a symbol.

The short sequence field 502 may comprise a plurality of short training sequence symbols, for example, 10 short training sequence symbols. Each short training sequence symbol may comprise transmission of information for a defined time interval, for example, 800 nanoseconds (ns). The duration of the short sequence field 502 may comprise a time interval, for example, about 8 microseconds (μs). The short sequence field 502 may be utilized by a receiver, for example, receiver 201, for a plurality of. reasons, for example, signal detection, automatic gain control (AGC) for low noise amplification circuitry, diversity selection such as performed by rake receiver circuitry, coarse frequency offset estimation, and timing synchronization.

The training symbol guard interval field 504 may comprise a time interval that separates, in time, receipt or transmission of a subsequent symbol in the PPDU. The duration of the training symbol guard interval field 504 may comprise a time interval, for example, about 1.6 μs. The training symbol guard interval field 504 may be utilized by an MT 116 to reduce the likelihood of inter-symbol interference between a preceding symbol, for example, a symbol transmitted during a short sequence field 502, and a succeeding symbol, for example, a symbol transmitted during a long sequence field 506.

The long sequence field 506 may comprise a plurality of long training symbols, for example, 2 long training symbols. Each long training symbol may comprise transmission of information for a defined time interval, for example, about 3.2 μs. The duration of the long training sequence, including the duration of the long sequence field 506, and the preceding training symbol guard interval field 504, may comprise a time interval of, for example, about 8 μs. The long training sequence field 506 may be utilized by an MT 116 for a plurality of reasons, for example, to perform fine frequency offset estimation, and/or channel estimation.

The guard interval field 508 may comprise a time interval that separates, in time, receipt or transmission of a subsequent symbol in the PPDU. The duration of guard interval field 508 may comprise a time interval, for example, about 800 ns. The guard interval field 508 may be utilized by an MT 116 to reduce the likelihood of inter-symbol interference between a preceding symbol, for example, a symbol transmitted during a long sequence field 506, and a succeeding symbol, for example, a symbol transmitted during the signal SIG-N field 510.

The signal SIG-N field 510 may comprise, for example, a signal symbol. Each signal symbol may comprise transmission of information for a defined time interval, for example, about 3.2 μs. The signal field 510 may be utilized by the MT 116 to implement transmission parameter signaling (TPS). The duration of the single symbol, including the duration of the signal SIG-N field 510, and the preceding guard interval field 508, may comprise a time interval, for example, about 4 μs. The signal SIG-N field 510 may be utilized by the MT 116 to establish a plurality of configuration parameters associated with receipt of a physical layer service data unit (PSDU) via an RF channel.

The guard interval field 512a may comprise a time interval that separates, in time, receipt or transmission of a subsequent symbol in the PPDU. The duration of guard interval field 512a may comprise a time interval, for example, about 800 ns. The guard interval field 512a may be utilized by the MT 116 to reduce the likelihood of inter-symbol interference between a preceding symbol, for example, a symbol transmitted during a signal SIG-N field 510, and a succeeding symbol, for example, a symbol transmitted during a the data field 514a. Each successive guard interval field in the plurality of guard interval fields 512a, . . . , 512b may be utilized by the MT 116 to reduce the likelihood of inter-symbol interference between a preceding symbol, for example, a symbol transmitted during the plurality of data fields 514a, . . . , 514b, and a succeeding symbol in the plurality of data fields 514a, . . . , 514b.

A data field 514a, in the plurality of data fields 514a, . . . , 514b, may comprise, for example, a data symbol. Each data symbol may comprise transmission, for a defined time interval, for example, about 3.2 μs. The duration of each data interval, including the duration of a data field in the plurality of data fields 514a, . . . , 514b, and the preceding guard interval field in the plurality of guard interval fields 512a, . . . , 512b, may comprise a time interval, for example, about 4 μs. The plurality of data fields 514a, . . . , 514b may be utilized by a receiver, for example, receiver 201, receive information that is contained in a PSDU data payload received via an RF channel.

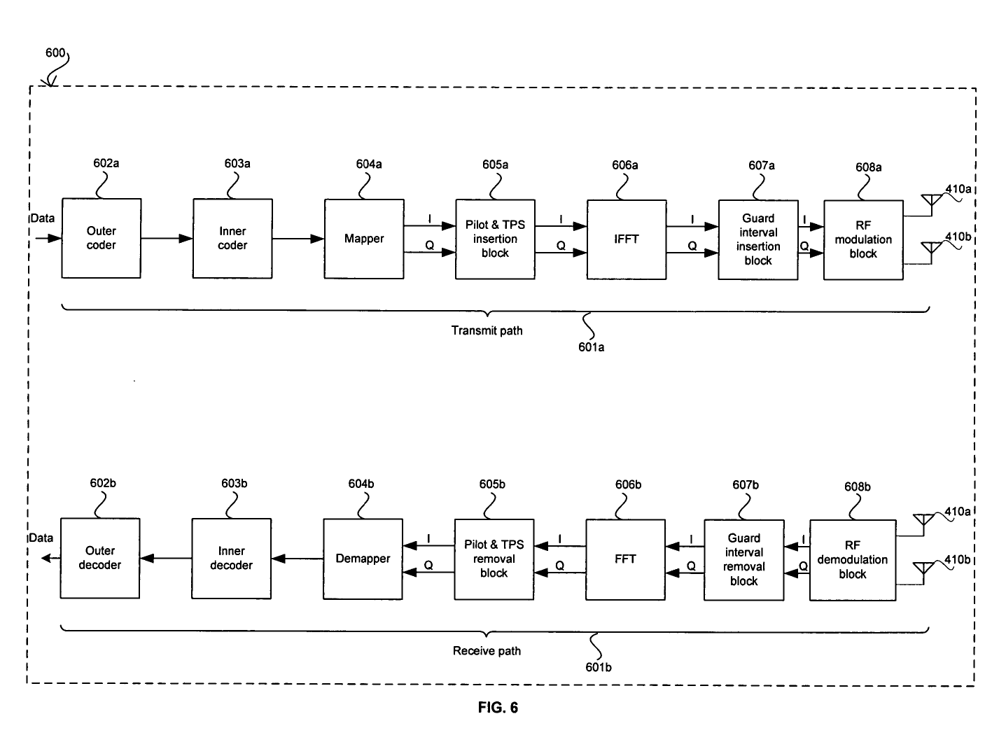

FIG. 6 is a block diagram illustrating an exemplary reconfigurable OFDM chip, in accordance with an embodiment of the invention. Referring to FIG. 6, there is shown a reconfigurable OFDM block 600 that may comprise a transmit path 601a and a receive path 601b. The transmit path 601a may comprise an outer coder 602a, an inner coder 603a, a mapper 604a, a pilot and transmission parameter signaling (TPS) insertion block 605a, an inverse fast Fourier transform (IFFT) block 606a, a guard interval insertion block 607a, and a radio frequency (RF) modulation block 608a. The receive path 601b may comprise an RF modulation block 608b, a guard interval removal block 607b, a FFT (FFT) block 606b, a pilot and TPS removal block 605b, a demapper 604b, an inner decoder 603b, and an outer decoder 602b.

The outer coder 602a may comprise suitable logic, circuitry, and/or code that may be adapted to generate error detection and/or error correction codes that may be computed based on at least a portion of the bits contained in a frame. For example, the outer coder 602a may be adapted to perform Reed-Solomon forward error correction (FEC) code generation. A Reed-Solomon code may be characterized by a tuple (N,K), where N may represent a number of octets containing information from the frame, and K may represent a number of octets containing parity check information. In various embodiments of the invention, the parameter K may be set to a configurable value ranging from K=7 to K=9, for example.

The inner coder 603a may comprise suitable logic, circuitry, and/or code that may be adapted to generate error detection and/or error correction codes that may be computed based on a plurality of bits contained within a frame. For example, the inner coder 603a may be adapted to perform binary convolutional code (BCC) generation on the output data generated by the outer coder 602a. The inner coder 603a may be configured to perform BCC based on a coding rate R=½, for example, where R may indicate a number of redundant bits that may be contained within a given plurality of BCC encoded bits. The value R may be set to a configurable value comprising R=⅔, R=¾, or R=⅚, for example.

The mapper 604a may comprise suitable logic, circuitry, and/or code that may be adapted to map one or more bits received from the inner coder 603a to a symbol based on a specified modulation constellation. For example, the mapper 604a may be adapted to perform X-QAM, where X indicates the size of the constellation to be used for quadrature amplitude modulation (QAM). The selection of a value for X may correspond to a modulation type. The mapper 604a may be configured to select a modulation type that may be utilized for mapping bits to symbols. Examples of modulation types may comprise binary phase shift keying (BPSK), quaternary phase shift keying (QPSK), 16-QAM, or 64-QAM, for example. The mapping performed by the mapper 604a may produce a modulated signal that comprises an in-phase (I) component and a quadrature phase (Q) component, for example. The signal generated by the mapper 604a may comprise a plurality of symbols. Each of the symbols contained in the signal may be referred to as an OFDM symbol. An OFDM symbol may be associated with a plurality of frequency carriers, where a frequency carrier may represent a signal that is transmitted at a given carrier frequency. Each frequency carrier associated with an OFDM symbol may utilize a different carrier frequency. A portion of the bits encoded into the OFDM symbol by the mapper 604a may be associated with one or more of the frequency carriers.

The pilot and TPS insertion block 605a may comprise suitable logic, circuitry, and/or code that may be adapted to insert OFDM pilot symbols and/or transmission parameters symbols into the signal generated by the mapper 604a. The IFFT 606a may comprise suitable logic, circuitry, and/or code that may be adapted to perform an IFFT or inverse discrete Fourier transform (IDFT) operation on the signal output from the pilot and TPS insertion block 605a. The IFFT 606a may be characterized by a number of points where the number of points in the IFFT or IDFT implementation may be equal to, or greater than the number of frequency carriers associated with an OFDM symbol. The number of points utilized by the IFFT 606a may be set to a configurable value ranging from 64 points to 8,192 points, for example. The signal generated by the IFFT 606a may be referred to as a spatial stream. The IFFT 606a may implement a one-dimensional IFFT or IDFT algorithm for data, text, and/or audio applications, and/or may implement a two-dimensional IFFT or IDFT algorithm for images and/or video applications, for example. The guard interval insertion block 607a may comprise suitable logic, circuitry, and/or code that may be adapted to insert a guard interval 508 into the spatial stream. The time duration of the guard interval inserted by the guard interval insertion block 607a may be set to a configurable value ranging from 400 ns and 800 ns, for example.

The RF modulation block 608a may comprise suitable logic, circuitry, and/or code that may be adapted to modulate the spatial stream by utilizing a plurality of frequency carriers. The number of frequency carriers utilized may be configurable and may differ in number for a signal transmitted via an IEEE 802.11 channel, an IEEE 802.16 channel, or a DVB-H channel, for example. The frequency spacing between frequency carriers may also vary, for example. In these regards, the operating bandwidth of the RF modulation block 608a may be set to a configurable value ranging from 20 MHz and 80 Mhz, for example. The frequency carriers may utilize a range of carrier frequencies that differ for a signal transmitted via an IEEE 802.11 channel, an IEEE 802.16 channel, or a DVB-H channel, for example. In this regard, the carrier frequencies utilized by the RF modulation block 608a may be configurable. The modulated spatial stream generated by the RF modulation block 608a may be transmitted via an antenna 410a or 410b, for example.

The RF demodulation block 608b may comprise suitable logic, circuitry, and/or code that may be adapted to demodulate an RF signal received via an antenna 410a or 410b, for example. The operating bandwidth of the RF demodulation block 608b may be set to a configurable value corresponding to the corresponding operating bandwidth that was utilized by the RF modulation block 608a when generating the transmitted signal, for example. The demodulating frequencies utilized by the RF demodulation block 608b may be configurable corresponding to the carrier frequencies utilized by the RF modulation block 608a when generating the transmitted signal, for example.

The guard interval removal block 607b may comprise suitable logic, circuitry, and/or code that may be adapted to remove a guard interval 508 from a received RF signal. The time interval removed by the guard interval removal block 607b may be set to a configurable value ranging from 400 ns and 800 ns, for example.

The fast Fourier transform (FFT) 606b may comprise suitable logic, circuitry, and/or code that may be adapted to perform an FFT or discrete Fourier transform (DFT) operation on the signal output from the guard interval removal block 607b. The FFT 606b may be characterized by a number of points where the number of points in the FFT or DFT implementation may be equal to the number of points utilized by the corresponding IFFT 606a utilized when generating the transmitted signal. The number of points utilized by the FFT 606b may be set to a configurable value that corresponds to the corresponding number of points utilized by the IFFT 606a when generating the transmitted signal, for example. The FFT 606b may implement a one-dimensional FFT or DFT algorithm corresponding to the algorithm utilized when generating the transmitted signal, for example.

The pilot and TPS removal block 605b may comprise suitable logic, circuitry, and/or code that may be adapted to remove OFDM pilot symbols and/or transmission parameters symbols from a received signal.

The demapper 604b may comprise suitable logic, circuitry, and/or code that may be adapted to demap a symbol in a received signal into one or more bits based on a specified demodulation constellation. The specified demodulation constellation may be configurable to correspond to the modulation type utilized when generating the transmitted signal, for example. For example, if the corresponding mapper 604a utilized a 16-QAM modulation type, the demapper 604b may utilize a demodulation constellation based on the 16-QAM modulation type.

The inner decoder 603b may comprise suitable logic, circuitry, and/or code that may be adapted to decode error detection and/or error correction codes in a received signal. The decoding of the error detection and/or error correction code may result in retrieval of the binary information that was encoded by the corresponding inner coder 603a when generating the transmitted signal. The inner decoder 603b may implement an inner decoding algorithm corresponding to the inner coding algorithm utilized by the inner coder 603a when generating the transmitted signal. For example, the inner decoder 603b may be adapted to perform binary convolutional code (BCC) generation. The inner decoder 603b may utilize a value for the coding rate, R, may be set to a configurable value corresponding to the coding rate utilized by the inner coder 603a when generating the transmitted signal.

The outer decoder 602b may comprise suitable logic, circuitry, and/or code that may be adapted to decode error detection and/or error correction codes in a received signal. The decoding of the error detection and/or error correction code may result in retrieval of the binary information that was encoded by the corresponding outer coder 602a when generating the transmitted signal. The outer decoder 602b may implement an outer decoding algorithm corresponding to the outer coding algorithm utilized by the outer coder 602a when generating the transmitted signal. For example, the outer decoder 602b may be adapted to perform Reed-Solomon forward error correction (FEC) decoding. In various embodiments of the invention, the outer decoder 602b may utilize a value for the parameter K may be set to configurable value corresponding to the value of K utilized by the outer coder 602a when generating the transmitted signal.

In operation, in the transmit path 601a, the processor 404a may determine values for a set of configurable parameters in the OFDM chip 404c based on information retrieved from the memory 404d, in various embodiments of the invention. Software may be utilized to store information in the memory 404d that may be subsequently retrieved by the processor 404a. The processor 404b may configure the outer coder 602a to utilize Reed-Solomon FEC code generation with the parity check parameter set to a value K=7, for example. The processor 404b may configure the inner coder 603a to utilize BCC code generation with the coding rate parameter set to a value R=½, for example. The processor 404b may configure the mapper 604a to utilize the BPSK modulation type, for example. The processor 404b may configure the IFFT 605a to utilize a 64 point IFFT algorithm, for example. The processor 404b may configure the guard interval insertion block 607a to insert an 800 ns guard band, for example. The processor 404b may configure the RF modulation block 608a to utilize a 20 MHz operating bandwidth, for example. The transmit path 601a may transmit a frame based on the configured parameters.

Based on information contained in the memory 404d, the processor 404b may determine if a signal is to be transmitted via a cellular channel, an IEEE 802.11 channel, an IEEE 802.16 channel or a DVB-H channel, for example. The processor 404b may transmit a first portion of a frame, for example the header and preamble, utilizing a first set of configurable parameters such as described above, for example. Based on subsequent information retrieved from the memory 404d, the processor 404b may modify at least a portion of the configurable parameters in the OFDM chip 404c. The modified set of parameters may be utilized when transmitting the payload portion of the frame, for example. For example, the processor 404b may reconfigure the mapper 604a to utilize the 64-QAM modulation type when transmitting the payload portion of the frame.

In the receive path 601b, the processor 404b may determine values for a set of configurable parameters in the OFDM chip 404c based on software, information retrieved from the memory 404d and/or information contained in the header and/or preamble fields 502, 506 and/or 510, in a received frame, in various embodiments of the invention. When receiving the header and/or preamble fields, the processor 404b may configure the outer decoder 602b to utilize Reed-Solomon FEC decoding with the parity check parameter set to a value K=7, for example. The processor 404b may configure the inner decoder 603b to utilize BCC decoding with the coding rate parameter set to a value R=½, for example. The processor 404b may configure the demapper 604b to utilize the BPSK modulation type, for example. The processor 404b may configure the FFT 605b to utilize a 64-point FFT algorithm, for example. The processor 404b may configure the guard interval removal block 607b to remove an 800 ns guard band, for example. The processor 404b may configure the RF demodulation block 608b to utilize a 20 MHz operating bandwidth, for example. The receive path 601b may receive a frame based on the configured parameters.

Based on information contained in the header and/or preamble fields of the frame, the processor 404b may determine if the received signal is from a cellular channel, an IEEE 802.11 channel, an IEEE 802.16 channel or a DVB-H channel, for example. Based on information contained in the header and/or preamble fields, for example TPS information, the processor 404b may modify at least a portion of the configurable parameters in the OFDM chip 404c to receive the payload portion of the frame, for example. For example, the processor 404b may reconfigure the demapper 604b to utilize the 64-QAM modulation type when receiving the payload portion of the frame.

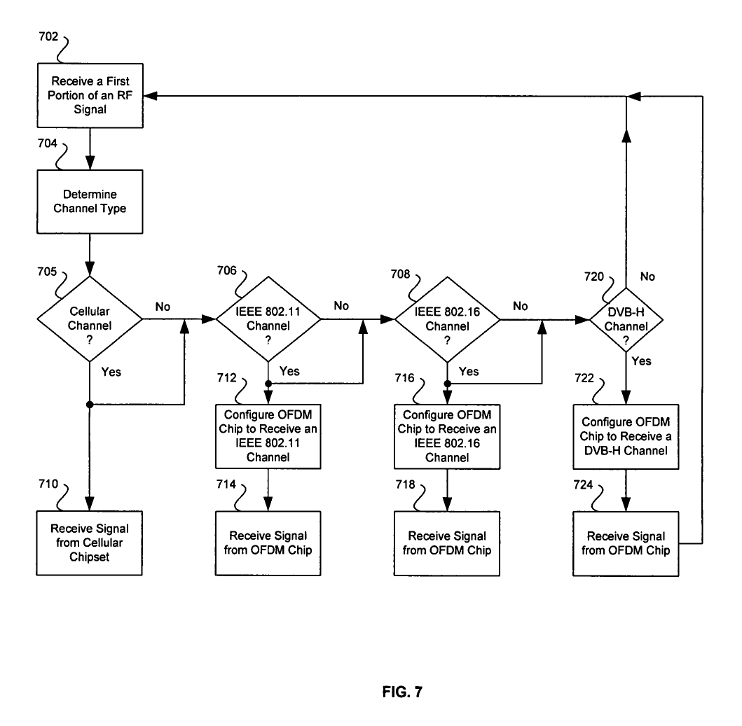

FIG. 7 is a flow chart illustrating exemplary steps for reconfiguring a reconfigurable OFDM radio, in accordance with an embodiment of the invention. Referring to FIG. 7 in step 702 the MT 116 may receive a first portion of an RF signal. The first portion may comprise at least a portion of preamble and/or header information contained in a frame. In step 704, the MT may determine a channel type that corresponds to the channel from which the RF signal is being received. In step 705, if the channel type determined in step 704 comprises a cellular channel, in step 710, the processor 404b may receive a signal that is processed by the cellular chipset 404a. To support collaborative communication, step 706 may also follow step 705. In step 706, if the channel type determined in step 704 comprises an IEEE 802.11 channel, in step 712, the processor 404b may configure the OFDM chip 404c to receive the RF signal via an IEEE 802.11 channel. To support collaborative communication, step 708 may also follow step 706. In step 714 the processor 404b may receive a signal that is processed by the OFDM chip 404c. In step 708, if the channel type determined in step 704 comprises an IEEE 802.16 channel, in step 716, the processor 404b may configure the OFDM chip 404c to receive the RF signal via an IEEE 802.16 channel. To support collaborative communication, step 720 may also follow step 708. In step 718 the processor 404b may receive a signal that is processed by the OFDM chip 404c. In step 720, if the channel type determined in step 704 comprises a DVB-H channel, in step 722, the processor 404b may configure the OFDM chip 404c to receive the RF signal via a DVB-H channel. In step 724 the processor 404b may receive a signal that is processed by the OFDM chip 404c. Step 702 may follow step 724. If the channel type determined in step 704 is not determined to comprise a DVB-H channel, step 702 may follow step 720.

Various embodiments of the invention may comprise a system for receiving information wirelessly, the system may comprise a processor 404b that reconfigures a single OFDM chip 404c to process a received DVB-H video broadcast signal and at least one of the following: a received IEEE 802.11 WLAN signal, and a received IEEE 802.16 MAN signal. The processor 404b may initiate the reconfiguring based on frame header information and/or frame preamble information. The processor 404b may configure an outer decoding method and/or an inner decoding method during the reconfiguring. The processor 404b may also configure a modulation type, an FFT algorithm and/or an DFT algorithm, an operating bandwidth, and/or a guard interval during the reconfiguring. The processor 404b may receive an RF signal comprising the DVB-H video broadcast signal, the IEEE 802.11 WLAN signal, the IEEE 802.16 MAN signal, or a cellular signal. The processor 404b may transcode the received signal and subsequently transmit a transcoded RF signal via one of the following: an IEEE 802.11 WLAN channel, an IEEE 802.16 MAN channel, and/or a cellular channel. The processor 404b may receive an RF signal comprising one of the DVB-H video broadcast signal, the IEEE 802.11 WLAN signal, the IEEE 802.16 MAN signal, or a cellular signal. The processor 404b may also receive a corresponding subsequent RF signal comprising a different signal from the group of signals comprising the DVB-H video broadcast signal, the IEEE 802.11 WLAN signal, the IEEE 802.16 MAN signal, or the cellular channel, in a collaborative communication.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for receiving information wirelessly, the method comprising reconfiguring a single OFDM chip to process a received DVB-H video broadcast signal and at least one of the following: a received IEEE 802.11 WLAN signal, and a received IEEE 802.16 MAN signal.

2. The method according to claim 1, further comprising initiating said reconfiguring based on at least one of the following: frame header information and frame preamble information.

3. The method according to claim 1, further comprising configuring an outer decoding method during said reconfiguring.

4. The method according to claim 1, further comprising configuring an inner decoding method during said reconfiguring.

5. The method according to claim 1, further comprising configuring a modulation type during said reconfiguring.

6. The method according to claim 1, further comprising configuring at least one of the following: a fast Fourier transform algorithm and a discrete Fourier transform algorithm, during said reconfiguring.

7. The method according to claim 1, further comprising configuring an operating bandwidth during said reconfiguring.

8. The method according to claim 1, further comprising configuring a guard interval during said reconfiguring.

9. The method according to claim 1, further comprising receiving an RF signal comprising one of the following: said DVB-H video broadcast signal, said IEEE 802.11 WLAN signal, said IEEE 802.16 MAN signal, and a cellular signal, and subsequently transmitting a transcoded RF signal via one of the following: an IEEE 802.11 WLAN channel, an IEEE 802.16 MAN channel, and a cellular channel.

10. The method according to claim 1, further comprising receiving an RF signal comprising one of the following: said DVB-H video broadcast signal, said IEEE 802.11 WLAN signal, said IEEE 802.16 MAN signal, and a cellular signal, and receiving a corresponding subsequent RF signal comprising a different one of said one of the following: said DVB-H video broadcast signal, said IEEE 802.11 WLAN signal, said IEEE 802.16 MAN signal, and said cellular channel, in a collaborative communication.

11. A system for receiving information wirelessly, the system comprising a processor that reconfigures a single OFDM chip to process a received DVB-H video broadcast signal and at least one of the following: a received IEEE 802.11 WLAN signal, and a received IEEE 802.16 MAN signal.

12. The system according to claim 11, wherein said processor initiates said reconfiguring based on at least one of the following: frame header information and frame preamble information.

13. The system according to claim 11, wherein said processor configures an outer decoding method during said reconfiguring.

14. The system according to claim 11, wherein said processor configures an inner decoding method during said reconfiguring.

15. The system according to claim 11, wherein said processor configures a modulation type during said reconfiguring.

16. The system according to claim 11, wherein said processor configures at least one of the following: a fast Fourier transform algorithm and a discrete Fourier transform algorithm, during said reconfiguring.

17. The system according to claim 11, wherein said processor configures an operating bandwidth during said reconfiguring.

18. The system according to claim 11, wherein said processor configures a guard interval during said reconfiguring.

19. The system according to claim 11, wherein said processor receives an RF signal comprising one of the following: said DVB-H video broadcast signal, said IEEE 802.11 WLAN signal, said IEEE 802.16 MAN signal, and a cellular signal, and subsequently transmits a transcoded RF signal via one of the following: an IEEE 802.11 WLAN channel, an IEEE 802.16 MAN channel, and a cellular channel.

20. The system according to claim 11, wherein said processor receives an RF signal comprising one of the following: said DVB-H video broadcast signal, said IEEE 802.11 WLAN signal, said IEEE 802.16 MAN signal, and a cellular signal, and receives a corresponding subsequent RF signal comprising a different one of said one of the following: said DVB-H video broadcast signal, said IEEE 802.11 WLAN signal, said IEEE 802.16 MAN signal, and said cellular channel, in a collaborative communication.

21. A machine-readable storage having stored thereon, a computer program having at least one code section for receiving information wirelessly, the at least one code section being executable by a machine for causing the machine to perform steps comprising reconfiguring a single OFDM chip to process a received DVB-H video broadcast signal and at least one of the following: a received IEEE 802.11 WLAN signal, and a received IEEE 802.16 MAN signal.

22. The machine-readable storage according to claim 21, further comprising code for initiating said reconfiguring based on at least one of the following: frame header information and frame preamble information.

23. The machine-readable storage according to claim 21, further comprising code for configuring an outer decoding method during said reconfiguring.

24. The machine-readable storage according to claim 21, further comprising code for configuring an inner decoding method during said reconfiguring.

25. The machine-readable storage according to claim 21, further comprising code for configuring a modulation type during said reconfiguring.

26. The machine-readable storage according to claim 21, further comprising code for configuring at least one of the following: a fast Fourier transform algorithm and a discrete Fourier transform algorithm, during said reconfiguring.

27. The machine-readable storage according to claim 21, further comprising code for configuring an operating bandwidth during said reconfiguring.

28. The machine-readable storage according to claim 21, further comprising code for configuring a guard interval during said reconfiguring.

29. The machine-readable storage according to claim 21, further comprising code for receiving an RF signal comprising one of the following: said DVB-H video broadcast signal, said IEEE 802.11 WLAN signal, said IEEE 802.16 MAN signal, and a cellular signal, and subsequently transmitting a transcoded RF signal via one of the following: an IEEE 802.11 WLAN channel, an IEEE 802.16 MAN channel, and a cellular channel.

30. The machine-readable storage according to claim 21, further comprising code for receiving an RF signal comprising one of the following: said DVB-H video broadcast signal, said IEEE 802.11 WLAN signal, said IEEE 802.16 MAN signal, and a cellular signal, and receiving a corresponding subsequent RF signal comprising a different one of said one of the following: said DVB-H video broadcast signal, said IEEE 802.11 WLAN signal, said IEEE 802.16 MAN signal, and said cellular channel, in a collaborative communication.
